(19) United States
(12) Patent Application Publication
(10) Pub. No.: US 2008/0170361 A1
(43) Pub. Date: Jul. 17, 2008

(54) Receiving Device Structure For Receiving Computer Peripherals And Computer Main Body

(75) Inventor: Moon Sang Ahn, Saha-gu (KR)

Correspondence Address: Hyun Jong Park;TUCHMAN & PARK LLC, 41 White Birch Road, Redding, CT, 06896-2209, US

(73) Assignee: RECOTECH CO., LTD., Haeundae-gu (KR)

(21) Appl. No.: 12/028,271

(22) Filed: Feb. 8, 2008

Related U.S. Application Data
(63) Continuation of application No. PCT/KR2006/003127, filed on Aug. 9, 2006.

(30) Foreign Application Priority Data
Aug. 10, 2005 (KR) 10-2005-0073377
Aug. 9, 2006 (KR) 20-2006-0021374

(51) Int. Cl. G06F 1/16

(52) U.S. Cl. 361/683

(57) ABSTRACT

Disclosed herein is a receiving device for integrally receiving peripherals and a main body of a computer. The receiving device includes upper and lower plates. A rear plate connects rear ends of the upper and lower plates to each other. A pair of side plates connects side ends of the upper and lower plates to each other, and has on upper and lower portions of inner surfaces thereof slide grooves. Each of open plates is hinged at one end thereof to each through hole and is rotated horizontally to be opened. Upper and lower slide plates are slidably mounted to the slide grooves. Further, a monitor supporting plate is transversely mounted to the side plates, and includes a lower support part on which the monitor is seated, and an upper support part provided to be perpendicular to the lower support part.

### REFERENCE TO RELATED APPLICATIONS

This is a continuation of pending International Patent Application PCT/KR2006/003127 filed on Aug. 9, 2006, which designates the United States and claims priority of Korean Patent Application No. 10-2005-0073377 filed on Aug. 10, 2005; Korean Patent Application No. 20-2006-0021374 filed on Aug. 9, 2006.

### FIELD OF THE INVENTION

The present invention relates, in general, to a receiving device structure for receiving peripherals and a main body of a computer and, more particularly, to a receiving device structure for receiving peripherals and a main body of a computer, which is constructed so that computer peripherals, including a fax/printer, a monitor, a speaker, etc., are received integrally along with a main body, and are placed on a work surface, such as a desk, thus increasing working efficiency and space utilization.

### BACKGROUND OF THE INVENTION

Generally, a computer uses peripherals, including a monitor, a speaker, a mouse, a fax/printer, etc., as well as a main body. In order to use the peripherals, they are separately arranged at predetermined positions around the main body.

However, the peripherals are arranged in a complicated manner at upper and lower positions of a work surface, such as a desk. Thus, the peripherals occupy a lot of space, and are separately arranged, so that working efficiency is very low.

### SUMMARY OF THE INVENTION

Accordingly, the present invention has been made keeping in mind the above problems occurring in the prior art, and an object of the present invention is to provide a receiving device structure for receiving peripherals and a main body of a computer, which is constructed so that computer peripherals, including a fax/printer, a monitor, a speaker, etc., are received integrally along with a main body, and are placed on a work surface, such as a desk, thus increasing space utilization.

Another object of the present invention is to provide a receiving device structure for receiving peripherals and a main body of a computer, which affords maximum efficiency to a worker when he or she works with the computer.

In order to accomplish the objects, the present invention provides a receiving device including upper and lower plates spaced apart from each other by a predetermined interval and defining upper and lower surfaces, a rear plate connecting rear ends of the upper and lower plates to each other, a pair of side plates connecting side ends of the upper and lower plates to each other, and having on upper and lower portions of inner surfaces of the side plates slide grooves such that the slide grooves face each other, with through openings being formed around the rear plate between the upper and lower plates, so that the main body is put into the receiving device through the through openings, an open plate hinged at one end thereof to each of the through holes and rotated horizontally to be opened, with at least one support rack being provided on an inner surface of the open plate, upper and lower slide plates slidably mounted to the slide grooves which are provided at upper and lower positions of the pair of side plates, and a monitor supporting plate transversely mounted to the pair of side plates, and including a lower support part on which the monitor is seated, and an upper support part provided to be perpendicular to the lower support part, thus supporting the monitor.

Further, according to another aspect of this invention, a receiving device includes upper and lower plates spaced apart from each other by a predetermined interval, and defining upper and lower surfaces, a rear plate connecting rear ends of the upper and lower plates to each other, a pair of side plates connecting side ends of the upper and lower plates to each other, and having on upper portions of inner surfaces of the side plates slide grooves such that the slide grooves face each other, with through openings being formed around the rear plate between the upper and lower plates, so that the main body is put into the receiving device through the through openings, an open plate hinged at one end thereof to each of the through holes and rotated horizontally to be opened, with at least one support rack being provided on an inner surface of the open plate, upper and lower slide plates, the upper slide plate being slidably mounted to the slide grooves which are provided at an upper position of side plate, the lower slide plate having on a lower surface thereof a guide rail, the guide rail being locked to a guide protrusion provided on a front portion of the lower plate so that the lower slide plate is slidably mounted to the lower plate, and a monitor supporting plate transversely mounted to the pair of side plates, and including a lower support part on which the monitor is seated, and an upper support part provided to be perpendicular to the lower support part, thus supporting the monitor.

According to a further aspect of this invention, a receiving device for integrally receiving a main body and peripherals of a computer, having a fax/printer, a monitor, and a speaker, includes upper and lower plates spaced apart from each other by a predetermined interval and defining upper and lower surfaces, a rear plate connecting rear ends of the upper and lower plates to each other, a pair of side plates connecting side ends of the upper and lower plates to each other and having on lower portions of inner surfaces of the side plates slide grooves such that the slide grooves face each other, with through openings being formed around the rear plate between the upper and lower plates, so that the main body is put into the receiving device through the through openings, an open plate hinged at one end thereof to each of the through holes and rotated horizontally to be opened, with a reflector being provided on an inner surface of the open plate, a lower slide plate slidably mounted to the slide grooves, a monitor supporting plate transversely mounted to the pair of side plates, and including a lower support part on which the monitor is seated, and an upper support part provided to be perpendicular to the lower support part, thus supporting the monitor, a receiving plate mounted to a lower portion of the upper plate, thus defining a space between the receiving plate and the upper plate, with a panel surface having a cut portion of a predetermined size being provided on a front end of the receiving plate, and a support rack detachably mounted to a guide rail provided on an outer surface of an upper portion of each of the side plates, so that a speaker is seated on the support rack.

According to the prior art, peripherals and a main body of a computer, are separately arranged at upper and lower positions of a work surface, such as a desk. However, the present invention is capable of integrally receiving the peripherals and the main body of the computer, and allows the peripherals and the main body to be placed on the work surface, thus maximizing working efficiency and space utilization.

The present invention provides an inexpensive and compact receiving device, in place of an expensive computer desk, and allows the receiving device to be directly placed on a work surface, such as a desk.

### BRIEF DESCRIPTION OF THE DRAWINGS

FIG. 1 is an exploded perspective view showing a receiving device for receiving peripherals and a main body of a computer, according to the present invention;

FIG. 2 is a perspective view showing the receiving device for receiving the peripherals and the main body of the computer, according to the present invention;

FIG. 3 is a perspective view showing the connection of a monitor supporting plate to the receiving device, according to the present invention;

FIG. 4 is a perspective view showing the connection of a mouse pad plate to the receiving device, according to the present invention;

FIG. 5 is an exploded perspective view showing another embodiment of the present invention;

FIG. 6 is a view showing the connection of a lower slide plate to the receiving device in FIG. 5; and

FIG. 7 is an exploded perspective view showing a further embodiment of the present invention.

### DESCRIPTION OF REFERENCE CHARACTERS OF IMPORTANT PARTS

10, 10′. upper, lower plate
12, 12′. slide groove
20. rear plate
30, 30′. side plate
40, 40′. open plate
50, 50′. upper, lower slide plate
60. monitor supporting plate
70. subsidiary plate
80. clamp
90. mouse pad plate

### DETAILED DESCRIPTION OF THE INVENTION

Hereinafter, the embodiments of the present invention will be described in detail with reference to the accompanying drawings.

### First Embodiment

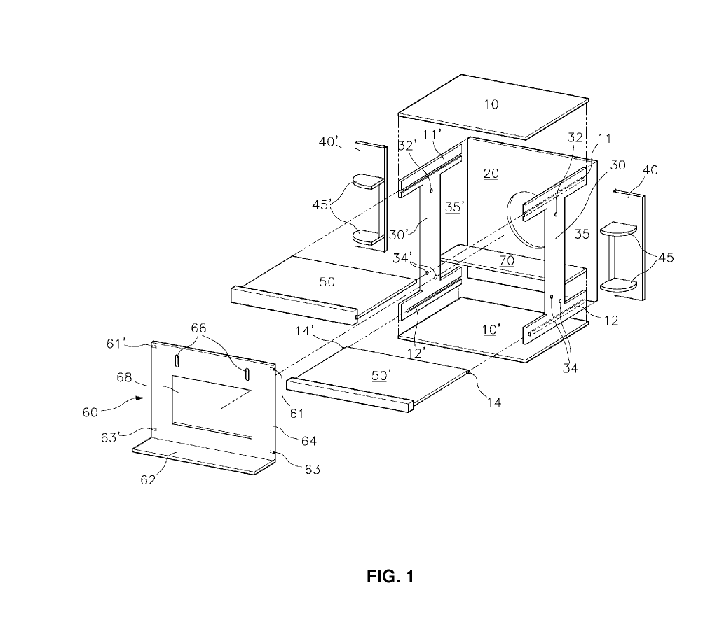

FIG. 1 is an exploded perspective view showing a receiving device for receiving peripherals and a main body of a computer, according to the present invention.

As shown in the drawing, the receiving device according to the present invention includes upper and lower plates 10 and 10′, a rear plate 20, and a pair of side plates 30 and 30′, which form a body of the receiving device. A pair of open plates 40 and 40′, upper and lower slide plates 50 and 50′, and a monitor supporting plate 60 are provided on the body.

The upper and lower plates 10 and 10′ are provided to be spaced apart from each other by a predetermined interval, that is, in consideration of the height of the main body of a computer or a monitor which is to be received between the upper and lower plates. Each of the plates has an area suitable for the width of the main body or a peripheral to be received.

The rear ends of the upper and lower plates 10 and 10′ are vertically connected to each other by the rear plate 20, whereas the front ends of the upper and lower plates are open.

In order to smoothly dissipate heat when a main body, which will be described below, is installed in the receiving device, and to connect the main body to an external power source, a through opening, having a proper size and shape, is preferably formed in the rear plate 20.

Meanwhile, both side ends of the upper and lower plates 10 and 10′ are vertically connected to a pair of side plates 30 and 30′. An upper slide groove 11 and a lower slide grove 12 are formed, respectively, along upper and lower portions of the inner surface of the side plate 30, that is, in a direction from a front end to a rear end. Further, an upper slide groove 11′ and a lower slide grove 12′ are formed, respectively, along upper and lower portions of the inner surface of the side plate 30′, that is, in a direction from a front end to a rear end.

Each of the side plates 30 and 30′ has a through opening 35 or 35′. The through opening 35 or 35′ is formed between the upper and lower plates 10 and 10′. In other words, the through opening 35 or 35′ is formed around the rear plate 20 between the upper and lower slide grooves 11 or 11′ and 12 or 12′.

Preferably, each through opening 35 or 35′ is bored to have a size sufficient to accommodate the main body of the computer, when the assembly of the receiving device according to the present invention is completed. In this case, the main body is placed on a subsidiary plate 70 which is disposed to span the lower portions of both the through openings 35 and 35′.

Further, a first mounting hole 32 or 32′ is formed in the upper portion of each of the side plates 30 and 30′. A plurality of second mounting holes 34 or 34′ is formed in the lower portion of each side plate 30 or 30′ so that the second mounting holes are spaced apart from each other by a predetermined interval. Thereby, a monitor supporting plate 60, which will be described below, is mounted to the side plates via the first and second mounting holes.

In this way, the body of the receiving device, according to the present invention, which has the upper and lower plates 10 and 10′, the rear plate 20, and the side plates 30 and 30′, is completed.

Further, the pair of open plates 40 and 40′, the upper and lower slide plates 50 and 50′, and the monitor supporting plate 60 are provided on the body assembled as described above. Each of the open plates 40 and 40′ is hinged at one end thereof to the through opening 35 formed in the side plate 30 or the through opening 35′ formed in the side plate 30′, and has on an inner surface thereof at least one support rack 45.

The open plate 40 or 40′ may be opened in a horizontal direction via a hinge coupling. Thus, when the open plate 40 or 40′ is opened outwards, it is possible to put the main body of the computer into the through opening 35 or 35′.

The upper and lower slide plates 50 and 50′ are slidably mounted to the upper slide grooves 11 and 11′ and the lower slide grooves 12 and 12′, respectively, so that the upper and lower slide plates 50 and 50′ may slide forwards or backwards.

Both sides of the upper slide plate 50 are fitted into the upper slide grooves 11 and 11′ in such a way that the upper slide plate can slide. Further, protrusions 14 and 14′ are provided on both side ends of the lower slide plate 50′ and are fitted into the lower slide grooves 12 and 12′ such that the lower slide plate can slide. As such, the upper and lower slide plate may be mounted by various methods that enable sliding.

The monitor supporting plate 60 is held by the side plates 30 and 30′. The monitor supporting plate 60 includes a lower support part 62 on which a monitor is seated, and an upper support part 64 which extends perpendicularly from the lower support part 62. In order to connect the monitor to the power and smoothly dissipate heat emitted by the monitor, a through opening 68 having a predetermined size is formed in the upper support part 64.

As known to those skilled in the art, when the monitor is constructed so that a display and a base are separated from each other, the display of the monitor is separated from the base thereof and thereafter only the display is seated on the monitor supporting plate, in order to efficiently utilize space. Further, when the monitor is constructed so that a base leans backwards, the base leans backwards and thereafter the display is seated on the monitor supporting plate.

Further, in order for the monitor supporting plate to be supported on the side plates 30 and 30′, mounting holes 61 and 61′ are formed in both sides of the upper portion of the monitor supporting plate 60 to correspond to the first mounting holes 32 and 32′ formed in the side plates 30 and 30′. Further, mounting holes 63 and 63′ are formed in both sides of the lower portion of the monitor supporting plate to correspond to the plurality of second mounting holes 34 and 34′.

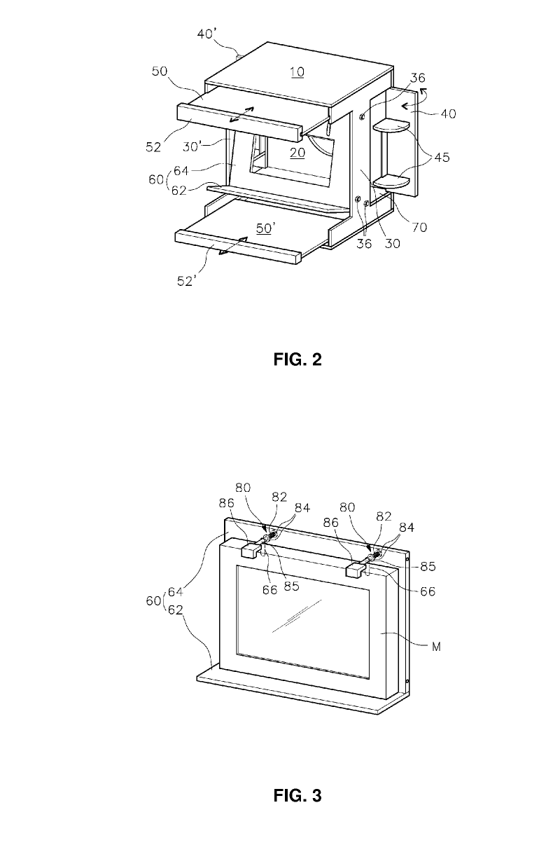

The state where the assembly of the receiving device is completed by coupling and fastening the plates, as described above, is shown in FIG. 2. FIG. 2 is a perspective view showing the receiving device for receiving the peripherals and the main body of the computer, according to the present invention.

As shown in the drawings, the upper slide plate 50 is slidably mounted to the upper portion of the receiving device, and the lower slide plate 50′ is slidably mounted to the lower portion of the receiving device. A space having a predetermined height is defined between the upper slide plate 50 and the upper plate 10. Printing paper or the like is placed on the upper slide plate 50 through the space, and a computer keyboard is placed on the lower slide plate 50′.

Preferably, a locking bar 52 is provided on the front end of the upper slide plate 50 to prevent paper from leaving the upper slide plate, in addition to allowing a user to hold and pull the locking bar. Further, a locking bar 52′ is provided on the front end of the lower slide plate 50′ to allow a user to hold and pull the locking bar, in addition to preventing the lower slide plate 50′ from entering the receiving device beyond a predetermined range.

Meanwhile, a fax/printer, having the functions of a printer, a copy machine, and a scanner, is placed on the upper plate 10, which defines the upper surface of the receiving device, and the open plates 40 and 40′, which are provided on both sides of the receiving device and are rotated in a horizontal direction to be opened, are completely opened out. In such a state, the main body of the computer is pushed into the receiving device to be placed in the space between the monitor supporting plate 60 and the rear plate 20, that is, to be placed on the subsidiary plate 70 which is provided to span the through openings.

A speaker is placed on the support rack 45 which is provided on each of the open plates 40 and 40′. Such a construction allows the sound emitting angle of the speaker to be appropriately adjusted using the rotatable open plates 40 and 40′.

Meanwhile, the monitor supporting plate 60 is positioned in the space defined between the upper and lower plates 10 and 10′. As described above, the monitor supporting plate 60 is transversely supported by the side plates 30 and 30′. The mounting holes 61 and 61′ (see, FIG. 1) formed in both sides of the upper portion of the monitor supporting plate 60 are aligned with the first mounting holes 32 and 32′ (see, FIG. 1) which are formed in the upper portions of the side plates 30 and 30′. In such a state, screws 36 are tightened into the aligned mounting holes. Next, each of the mounting holes 63 and 63′ (see, FIG. 1), which are formed in the lower portion of the monitor supporting plate, is aligned with one of the second mounting holes 34 or 34′ (see, FIG. 1), which are formed in the lower portion of each of the side plates 30 and 30′. In such a state, a fastening screw 36 is tightened into the aligned mounting holes.

In this case, the second mounting holes 34 and 34′ are spaced apart from each other. Thus, when a second mounting hole coupled to each mounting hole 63 or 63′ is changed, the lower portion of the monitor supporting plate may be moved with respect to the fixed upper portion of the monitor supporting plate by the interval between the second mounting holes. Thereby, the angle of the monitor supporting plate 60 may be adjusted at a predetermined angle with respect to a vertical surface.

Thus, the angle of the monitor, seated on the monitor supporting plate 60, can be adjusted to be appropriate for the person working with the computer.

Meanwhile, as described above, the monitor seated on the monitor supporting plate 60 may be inclined at a predetermined angle with respect to the vertical surface. However, in order to ensure safer coupling, the monitor is preferably coupled to the monitor supporting plate 60 via an additional device. FIG. 3 is a perspective view showing the connection of the monitor supporting plate to the receiving device, according to the present invention.

The connection of the monitor M to the upper portion of the upper support part 64 of the monitor supporting plate 60 is achieved using clamps 80.

Any structure may be used as the clamp 80, as long as it can maintain a temporary coupling. According to the present invention, as shown in the drawing, the clamp 80 includes a pair of disc members 84, a coil spring 82 interposed between the disc members 84, and a support rod 85. One end of the support rod 85 is connected to an end of the disc member 84, and the other end of the support rod 85 is connected to a coupling piece 86.

The coupling piece 86 of the support rod 85 and the pair of disc members 84 are provided on opposite sides of at least one through hole 66 which is formed in the upper portion of the upper support part 64 of the monitor supporting plate 60, so that the coupling piece 86 is elastically supported, and thereby the monitor M is coupled to the coupling piece 86.

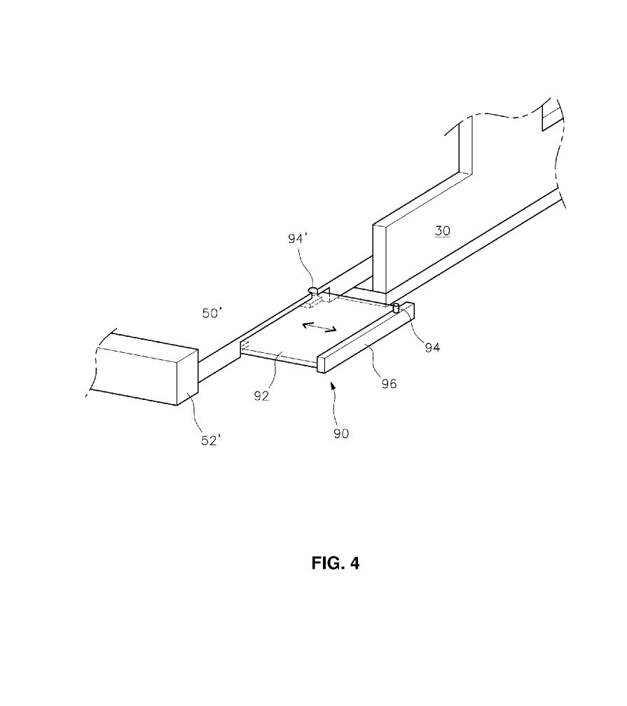

Meanwhile, according to the present invention, an additional mouse pad plate may be provided to be used as a mouse pad, which is a very important peripheral of the computer. FIG. 4 is a detailed perspective view showing the connection of the mouse pad plate to the receiving device, according to the present invention.

As shown in the drawing, the mouse pad plate 90 is slidably mounted to the receiving device, and is retracted into and pulled out from the side of the lower slide plate 50′ on which the keyboard is placed.

That is, when it is not necessary to use the keyboard, and the lower slide plate 50′ is thus pushed into the side plates 30 and 30′, the mouse pad plate 90 according to the present invention is also received in one side of the lower slide plate 50′. Meanwhile, when the lower slide plate 50′ is pulled out to use the keyboard, the mouse pad plate 90 may be freely pulled out from the lower slide plate.

To this end, the mouse pad plate 90 includes a panel 92 having a predetermined size, a protrusion 94 protruding from a side of the panel 92, and a subsidiary support part 96 vertically supporting the end of the panel 92.

When the mouse pad plate 90 is received in the lower slide plate 50′, the protrusion 94 allows the mouse pad plate 90 to be easily pulled out by a user. Preferably, a protrusion insert hole 94′ is formed in the lower slide plate 50′ to correspond to the shape of the protrusion 94.

When the mouse pad plate 90 is completely pulled out, the subsidiary support part 96 compensates for the height difference between the mouse pad plate and a work surface, such as a desk, thus keeping the panel 92 flat.

Meanwhile, the mouse pad plate 90 may not be completely received in the lower slide plate 50′ due to the subsidiary support part 96. In order to prevent this problem, the lower slide plate 50′ receiving the subsidiary support part 96 is constructed to match the shape of the subsidiary support part 96, and to receive the subsidiary support part 96 therein.

In this way, the present invention allows the main body and the peripherals, including a fax/printer, a monitor, a speaker, and a mouse, to be integrally received, and allows the main body and the peripherals to be directly placed on a work surface, such as a desk, thus maximizing space utilization.

Meanwhile, the present invention may be embodied as such, but the sliding structure of the lower slide plate 50′ may be changed.

### Second Embodiment

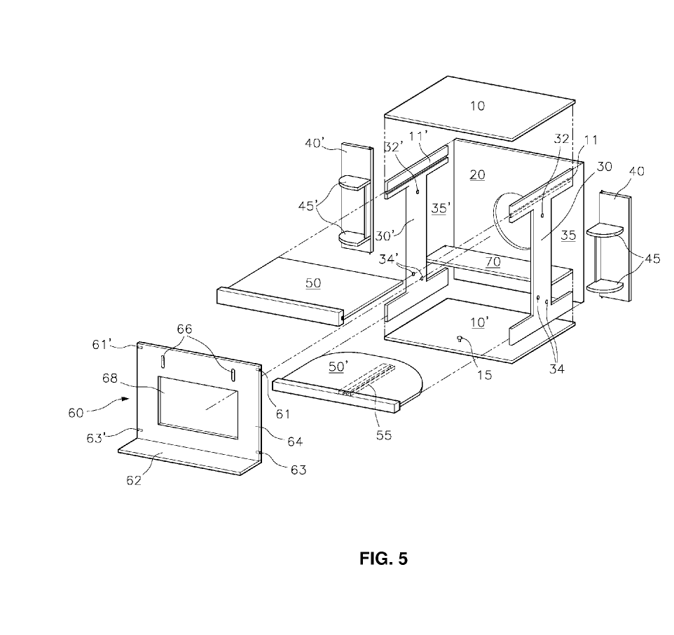

FIG. 5 is a detailed exploded perspective view showing another embodiment of the present invention.

As shown in the drawing, a receiving device includes a body having upper and lower plates 10 and 10′, a rear plate 20 coupling the upper and lower plates to each other, and a pair of side plates 30 and 30′. In this case, sliding grooves 11 and 11′ are formed only on the upper portions of the inner surfaces of the side plates 30 and 30′ to be opposite each other.

Further, unlike the upper slide plate 50, which is slidably mounted to the upper slide grooves 11 and 11′, the lower slide plate 50′ is formed such that a rear edge thereof is rounded, and a guide rail 55 is provided along the center on the lower surface of the lower slide plate 50′ in a direction from a front position to a rear position. A guide protrusion 15 protruding from the front portion of the lower plate 10 is slidably inserted into the guide rail 55.

Since other components which are not mentioned, for example, open plates 40 and 40′, a monitor supporting plate 60, a subsidiary plate 70, and a mouse pad plate 90, are equal to those of the above-described embodiment, they will not be described herein in detail.

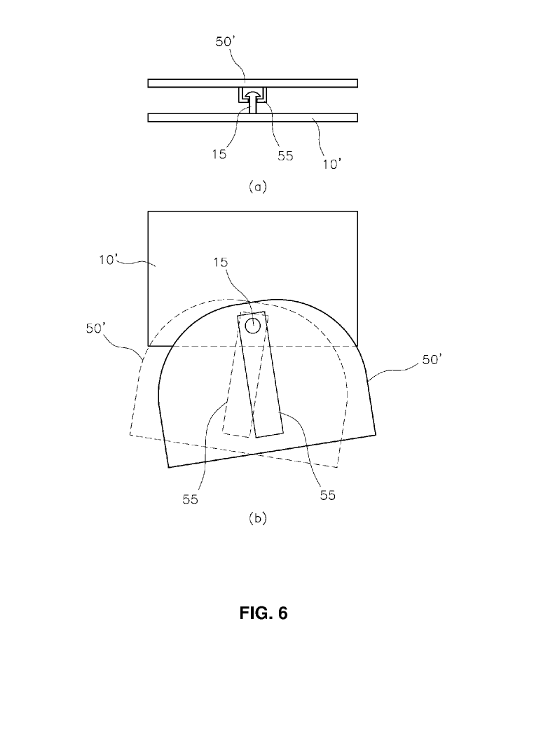

FIG. 6 is a detailed view showing the connection of the lower slide plate to the receiving device in FIG. 5. FIG. 6a is a view showing the coupling of the guide rail with the guide protrusion. FIG. 6b shows the operation of the lower slide plate.

As shown in FIG. 6a, the guide protrusion 15, provided at a predetermined position on the front portion of the center of the lower plate 10′, has the same shape as a screw having a head. The head of the guide protrusion 15 is inserted into the guide rail 55 which is provided on the lower surface of the lower slide plate 50′.

When the receiving device is assembled in this way and the lower slide plate 50′ is pulled forwards a predetermined distance, as shown in FIG. 6b, the guide protrusion 15 serves as a pivot, so that the lower slide plate 50′ is moved about the guide protrusion 15 to the left side (shown by dotted lines) and the right side (shown by a solid line).

Thus, when one or more persons work using the receiving device according to the present invention, the persons have only to move the lower slide plate 50′ leftwards and rightwards. That is, even if workers do not switch positions but remain sitting, both of them may use the keyboard. Thus, above all, the efficiency of computer work can be maximized for users.

Meanwhile, the present invention may be embodied as such, but the structure of support racks 45, a monitor supporting plate 60, and an upper plate may be changed.

### Third Embodiment

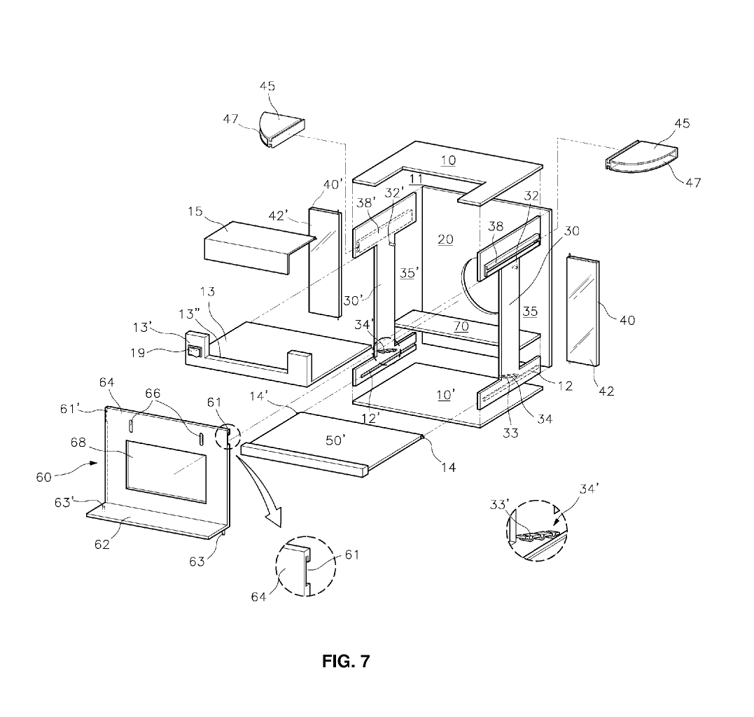

FIG. 7 is a detailed exploded perspective view showing a further embodiment of the present invention.

As shown in the drawing, a receiving device according to the embodiment includes a body having upper and lower plates 10 and 10′, a rear plate 20 coupling the upper and lower plates to each other, and a pair of side plates 30 and 30′. A receiving plate 13 having on a front end thereof a panel surface 13′ which is provided with a cut portion 13″ having a predetermined size is coupled to the lower portion of the upper plate 10, thus defining a space therebetween.

In this case, a cut portion 11 having a predetermined size is formed on the front end of the upper plate 10. A cover 15 is hinged to the cut portion 11 to open or close the cut portions 11 and 13″.

A power switch 19 for turning on or off the peripherals and the main body of the computer is provided at a predetermined position on the panel surface 13′ of the receiving panel 13, and is connected to a power adapter which is provided between the upper plate 10 and the receiving plate 13.

Further, a reflector 42 or 42′ is mounted to the inner surface of the open plate 40 or 40′, in place of one or more support racks 45, thus allowing a user to check the internal structure, including the main body placed on the subsidiary plate 70, while remaining sitting.

A guide rail 38 or 38′ is provided on the outer surface of the upper portion of each side plate 30 or 30′ in such a way as to be parallel to the upper plate 10. A support rack 45 or 45′ is detachably mounted to the corresponding guide rail 38 or 38′, so that a speaker can be seated on the support rack.

Each support rack 45 or 45′ further includes a compact-disc receiving slot 47 or 47′, so that a plurality of compact discs storing various programs and data which are frequently used can be tidily arranged.

Meanwhile, a locking protrusion 32 or 32′ is provided on the upper portion of each of the side plates 30 and 30′, and an inclination adjusting piece 34 or 34′ is provided on the lower portion of each of the side plates 30 and 30′ to be inclined at a predetermined angle downwards in a direction from a front end to a rear end, so that the monitor supporting plate 60 is coupled to the side plates 30 and 30′.

In this case, as shown in the drawing, hook-shaped locking grooves 61 and 61′, corresponding to the locking protrusions 32 and 32′, are provided on both sides of the upper portion of the upper support part 64 of the monitor supporting plate 60. Thus, the locking protrusions 32 and 32′ are fitted into the corresponding locking grooves 61 and 61′, so the monitor supporting plate 60 is hooked to the locking protrusions 32 and 32′. In this way, the assembly of the monitor supporting plate is completed.

Adjusting protrusions 63 and 63′ are provided on both sides of the lower surface of the lower support part 62 to correspond to the inclination adjusting pieces 34 and 34′. To this end, a plurality of grooves 33 or 33′ corresponding to the adjusting protrusions 63 and 63′ is provided on the upper surface of the inclination adjusting pieces 34 or 34′ at regular intervals.

Since other components which are not mentioned, for example, a subsidiary plate 70, a clamp 80 coupled to the monitor supporting plate 60, and a mouse pad plate 90 mounted to a lower slide plate 50′, are equal to those of the above-mentioned embodiment, they will not be described herein in detail. [87] As described above, the present invention is characterized in that a main body and peripherals of a computer are integrally received and are placed on a work surface, such as a desk. [88] Further, those skilled in the art will appreciate that various modifications, additions and substitutions are possible, without departing from the scope and spirit of the invention as disclosed in the accompanying claims.

### INDUSTRIAL APPLICABILITY

As described above, the present invention provides a receiving device, which integrally receives a main body and peripherals, including a fax/printer, a monitor, a speaker, etc., and places the main body and the peripherals on a work surface, such as a desk, thus increasing working efficiency and space utilization.

1. A receiving device for integrally receiving a main body and peripherals of a computer, including a fax/printer, a monitor, and a speaker, the receiving device comprising:
upper and lower plates spaced apart from each other by a predetermined interval, and defining upper and lower surfaces;
a rear plate connecting rear ends of the upper and lower plates to each other;
a pair of side plates connecting side ends of the upper and lower plates to each other, and having on upper and lower portions of inner surfaces of the side plates slide grooves such that the slide grooves face each other, with through openings being formed around the rear plate between the upper and lower plates, so that the main body is put into the receiving device through the through openings;
an open plate hinged at one end thereof to each of the through holes and rotated horizontally to be opened, with at least one support rack being provided on an inner surface of the open plate;
upper and lower slide plates slidably mounted to the slide grooves which are provided at upper and lower positions of the pair of side plates; and
a monitor supporting plate transversely mounted to the pair of side plates, and including a lower support part on which the monitor is seated, and an upper support part provided to be perpendicular to the lower support part, thus supporting the monitor.

2. A receiving device for integrally receiving a main body and peripherals of a computer, including a fax/printer, a monitor, and a speaker, the receiving device comprising:
upper and lower plates spaced apart from each other by a predetermined interval, and defining upper and lower surfaces;
a rear plate connecting rear ends of the upper and lower plates to each other;
a pair of side plates connecting side ends of the upper and lower plates to each other, and having on upper portions of inner surfaces of the side plates slide grooves such that the slide grooves face each other, with through openings being formed around the rear plate between the upper and lower plates, so that the main body is put into the receiving device through the through openings;
an open plate hinged at one end thereof to each of the through holes and rotated horizontally to be opened, with at least one support rack being provided on an inner surface of the open plate;
upper and lower slide plates, the upper slide plate being slidably mounted to the slide grooves which are provided at an upper position of the plate, the lower slide plate having on a lower surface thereof a guide rail, the guide rail being locked to a guide protrusion provided on a front portion of the lower plate so that the lower slide plate is slidably mounted to the lower plate; and
a monitor supporting plate transversely mounted to the pair of side plates, and including a lower support part on which the monitor is seated, and an upper support part provided to be perpendicular to the lower support part, thus supporting the monitor.

3. A receiving device for integrally receiving a main body and peripherals of a computer, including a fax/printer, a monitor, and a speaker, the receiving device comprising:
upper and lower plates spaced apart from each other by a predetermined interval, and defining upper and lower surfaces;
a rear plate connecting rear ends of the upper and lower plates to each other;
a pair of side plates connecting side ends of the upper and lower plates to each other, and having on lower portions of inner surfaces of the side plates slide grooves such that the slide grooves face each other, with through openings being formed around the rear plate between the upper and lower plates, so that the main body is put into the receiving device through the through openings;
an open plate hinged at one end thereof to each of the through holes and rotated horizontally to be opened, with a reflector being provided on an inner surface of the open plate;
a lower slide plate slidably mounted to the slide grooves;
a monitor supporting plate transversely mounted to the pair of side plates, and including a lower support part on which the monitor is seated, and an upper support part provided to be perpendicular to the lower support part, thus supporting the monitor;
a receiving plate mounted to a lower portion of the upper plate, thus defining a space between the receiving plate and the upper plate, with a panel surface having a cut portion of a predetermined size being provided on a front end of the receiving plate; and
a support rack detachably mounted to a guide rail provided on an outer surface of an upper portion of each of the side plates, so that a speaker is seated on the support rack.

4. The receiving device according to claim 1, further comprising:
a mouse pad plate mounted to a side end of the lower slide plate in such a way as to be retracted into or taken out of the lower slide plate, and comprising a panel having a predetermined size, a protrusion provided at a predetermined position on the panel, and a subsidiary support part vertically supporting an end of the panel.

5. The receiving device according to claim 1, wherein a subsidiary plate is provided on the through openings of the side plates to span the through openings, so that the main body of the computer is placed on the subsidiary plate.

6. The receiving device according to claim 1, wherein an upper portion of the upper support part of the monitor supporting plate and the monitor are coupled to each other via a clamp.

7. The receiving device according to claim 1, wherein a first mounting hole is formed in an upper portion of each of the side plates, second mounting holes are formed in a lower portion of each of the side plates to be spaced apart from each other by a predetermined interval, and mounting holes are formed in both side ends of the monitor supporting plate, so that the side plates and the monitor support plate are fastened to each other via fastening screws.

8. The receiving device according to claim 2, wherein the lower slide plate is formed such that a rear edge thereof is rounded.

9. The receiving device according to claim 3, wherein a cut portion having a predetermined size is provided on a front end of the upper plate, and a cover is hinged to the cut portion to open or close the cut portions.

10. The receiving device according to claim 9, further comprising: a power switch provided at a predetermined position on the panel surface of the receiving plate, and turning on or off the main body and peripherals of the computer.

11. The receiving device according to claim 3, further comprising: a compact-disc receiving slot formed in the support rack.

12. The receiving device according to claim 3, wherein a locking protrusion is provided on an upper portion of each of the side plates, and an inclination adjusting piece is provided on a lower portion of each of the side plates to be inclined downwards in a direction from a front end to a rear end at a predetermined angle, and a hook-shaped locking groove is provided on each of side ends of the upper support part to correspond to the locking protrusion, and an adjusting protrusion is provided on a side of a lower surface of the lower support part to correspond to the inclination adjusting piece.

13. The receiving device according to claim 12, further comprising: a plurality of grooves provided on an upper surface of the inclination adjusting piece at regular intervals and corresponding to the adjusting protrusion.
